(19) United States
(12) Patent Application Publication
(10) Pub. No.: US 2010/0247770 A1
(43) Pub. Date: Sep. 30, 2010

(54) METHOD FOR APPLYING COATING LIQUID, METHOD FOR FORMING COATED FILM, METHOD FOR FORMING A PATTERN BY USING THE SAME, AND METHOD FOR MANUFACTURING SEMICONDUCTOR DEVICE

(75) Inventors: Yosuke SAITO, Tokyo (JP); Hidenori YAMAGUCHI, Tokyo (JP)

Correspondence Address: YOUNG & THOMPSON, 209 Madison Street, Suite 500, Alexandria, VA, 22314, US

(73) Assignee: ELPIDA MEMORY, INC., Tokyo (JP)

(21) Appl. No.: 12/722,033

(22) Filed: Mar. 11, 2010

(30) Foreign Application Priority Data
Mar. 24, 2009 (JP) 2009-071717

(51) Int. Cl. B05D 5/00; B05D 3/00; B05D 3/02

(52) U.S. Cl. 427/256; 427/331; 427/346; 427/372.2

(57) ABSTRACT

Described are novel methods for applying a coating liquid, forming a coated film, forming a pattern by using the same, and manufacturing a semiconductor device. A coating liquid is applied onto a substrate using a method including forming a puddle of a mixture liquid containing a coating liquid and a diluting liquid on the substrate and spreading the mixture liquid over the surface of the substrate, forming a coated film. Alternatively, a coating liquid is applied onto a substrate using a method including dispensing a diluting liquid on a substrate to cover the entire surface of the substrate with the diluting liquid, dispensing a coating liquid on the diluting liquid forming an area where the mixture liquid containing the coating liquid and the diluting liquid is present, and spreading the mixture liquid over the surface of the substrate to apply the coating liquid on the substrate, forming a coated film.

This application is based upon and claims the benefit of priority from Japanese patent application No. 2009-71717, filed on Mar. 24, 2009, the disclosure of which is incorporated herein in its entirety by reference.

### BACKGROUND OF THE INVENTION

1. Field of the Invention

An exemplary aspect of the invention relates to a method for applying a coating liquid, a method for forming a coated film, a method for forming a pattern by using the same, and a method for manufacturing a semiconductor device.

2. Description of the Related Art

To form a circuit pattern (hereinafter referred to as a pattern) used for a semiconductor device on a substrate to be processed, such as a wafer, a process that has been used includes forming a resist layer made of a photosensitive resist material (hereinafter referred to as a resist) on the substrate to be processed. The resist is formed of a solid component for fixing a pattern on the substrate to be processed and an organic solvent for making the solid component easily applicable, and spin coating has been typically used to provide a coated film.

As the pattern size has been miniaturized in recent years, a process of forming a coated film on the resist layer by spin-coating a water-soluble polymer material containing a shrink agent for adjusting the pattern size has been used. The water-soluble polymer material is also formed of a solid component that serves to adjust the pattern size and a solvent for making the solid component easily applicable onto the resist layer. Water is used as the solvent in many cases.

To form a coated film made of a coating liquid, such as a resist and a water-soluble polymer material, a solution of a desired material is first dispensed on a substrate to be processed, and the solution is then diffused over the substrate to be processed at a predetermined spin speed. Thereafter, the solvent, such as an organic solvent and water, is evaporated by adjusting the spin speed so that a desired film thickness is obtained, and rotating the substrate for a fixed period, whereby the coated film is fixed on the substrate. In this process, it is required not to cause coating nonuniformity or other striation or pinhole defects. Using a large amount of coating liquid can relatively easily avoid the coating nonuniformity and pinhole defects. This approach is, however, inefficient because most of the solution is discarded as waste liquid.

To address the problem, a method for providing a desired coated film but using a reduced amount of coating liquid has been proposed, for example, in Japanese Patent Laid-Open No. 61-91655. In this method, to prevent striation, a resist solvent is applied onto a wafer in advance, and a resist is then applied. Japanese Patent Laid-Open No. 61-150332 proposes a method for applying a resist onto a substrate with a stepped portion. The method includes dispensing a resist solvent, rotating a wafer to diffuse the resist solvent to the periphery of the wafer, drying the resist solvent, and applying a resist. As a result, the wettability of the stepped portion is improved and no uncoated portion is left. Japanese Patent Laid-Open No. 7-320999 proposes a method to provide a uniform coated film by using a small amount of coating liquid. To provide a desired coated film but reduce the amount of resist to be used, the method includes diffusing a coating liquid solvent over a substrate and controlling the spin speed at which the coating liquid is diffused and the period for which the coating liquid is supplied or the amount of coating liquid to be supplied. Any of the methods described above states that processing a coating liquid with a solvent before dispensed allows a uniform, coating-nonuniformity-free coated film to be provided without using a large amount of solution.

An exemplary aspect of the invention provides a novel method for applying a coating liquid, a novel method for forming a coated film, a novel method for forming a pattern by using the same, and a novel method for manufacturing a semiconductor device.

### SUMMARY OF THE INVENTION

A method for applying a coating liquid according to an exemplary embodiment is a method for applying a coating liquid onto a substrate, the method comprising:

(a1) forming a puddle (P0) of a mixture liquid comprising the coating liquid and a diluting liquid on the substrate; and

(b) spreading the mixture liquid over the surface of the substrate.

A method for applying a coating liquid according to an exemplary embodiment is a method for applying a coating liquid onto a substrate, the method comprising:

(a2-1) dispensing a diluting liquid on the substrate to cover the entire surface of the substrate with the diluting liquid;

(a2-2) dispensing the coating liquid on the diluting liquid to form an area where the mixture liquid comprising the coating liquid and the diluting liquid is present; and

(b) spreading the mixture liquid over the surface of the substrate.

A method for forming a coated film according to an exemplary embodiment comprises forming a coated film made of a coating liquid on a substrate by using the method for applying a coating liquid according to an exemplary embodiment.

A method for forming a pattern according to an exemplary embodiment comprises:

forming a resist layer on a substrate by using a resist solution as the coating liquid and the method for forming a coated film according to claim 18; and a non-water-soluble organic solvent as the diluting liquid in the method for forming a coated film according to an exemplary embodiment; and

exposing and developing the resist layer to form a resist pattern.

A method for forming a pattern according to an exemplary embodiment comprises:

forming a resist layer on a substrate;

before or after forming the resist layer, forming an anti-reflection film or a liquid-immersion top-coat layer on the substrate by using an anti-reflection film solution or a liquid-immersion top coat solution as the coating liquid and water, alcohol, or a mixture liquid thereof as the diluting liquid in the method for forming a coated film according to an exemplary embodiment; and

exposing and developing the resist layer to form a resist pattern.

A method for forming a pattern according to an exemplary embodiment comprises:

forming a resist pattern on a substrate;

forming a shrink agent layer on the substrate by using a shrink agent solution as the coating liquid and water, alcohol, or a mixture liquid thereof as the diluting liquid in the method for forming a coated film according an exemplary embodiment; and

baking and rinsing the shrink agent layer to shrink the resist pattern.

A method for manufacturing a semiconductor device according an exemplary embodiment comprises forming a pattern on a semiconductor substrate by using a mask having a pattern formed by using the method for forming a pattern according an exemplary embodiment.

An exemplary aspect of the invention described above provide a novel method for applying a coating liquid, a novel method for forming a coated film, a novel method for forming a pattern by using the same, and a novel method for manufacturing a semiconductor device.

### BRIEF DESCRIPTION OF THE DRAWINGS

FIGS. 1a, 1b and 1c diagrammatically show the steps of a method for applying a coating liquid according to an exemplary embodiment;

FIGS. 2a, 2b and 2c diagrammatically show the steps of a method for applying a coating liquid according to another exemplary embodiment;

FIGS. 3a, 3b and 3c diagrammatically show the steps of a method for shrinking a pattern by using a shrink agent;

FIG. 4 is a chart showing a time-dependent change of the spin speed of a substrate and the amount of each liquid to be dispensed in Example 1;

FIG. 5 is a chart showing a time-dependent change of the spin speed of a substrate and the amount of each liquid to be dispensed in Example 2; and

FIG. 6 diagrammatically shows pinhole defects produced in a case where the application method in Comparison Example is used and in a case where the application method Example 1 is used.

### DETAILED DESCRIPTION OF THE PREFERRED EMBODIMENTS

A water-soluble polymer material was applied to form a coated film as a trial in accordance with each of the methods described in Japanese Patent Laid-Open Nos. 61-91655, 61-150332 and 7-320999. Specifically, water, which is a solvent, was dispensed on a 12-inch wafer on which a KrF resist pattern had been formed. The wafer was then rotated to diffuse the water to the periphery of the wafer. Thereafter, a water-soluble polymer was applied. However, the water-soluble polymer solution did not uniformly spread, resulting in coating nonuniformity. To eliminate the coating nonuniformity, the amount of water was increased, and the spin speed and start-up acceleration after the solution was dispensed were variously changed, but the coating nonuniformity was not eliminated. The coating nonuniformity occurs because high repellency of the resist surface does not allow the wettability of the resist surface to be maintained.

So-called stationary coating method has therefore predominantly been used, in which 8 to 10 cc of a water-soluble polymer solution is dispensed on a stationary wafer and then the wafer is rotated to form a coated film.

However, when a water-soluble polymer coated film formed by using stationary coating method was used to shrink a resist pattern and manufacture a 1-GBit DRAM (Dynamic Random Access Memory), a large number of conduction defective chips were produced in the 6 to 8-inch area of the wafer, and hence the number of non-defective products disadvantageously decreased. A cause-finding investigation has revealed that the conduction defect occurred at the boundary between the portion where the water-soluble polymer solution was dispensed and the portion where no water-soluble polymer solution was dispensed and is a pattern blocked-type defect caused as follows. Air bubbles are caught when the applied solution spreads and produce pinholes in the water-soluble polymer coated film. In the resist pattern containing the pinholes, abnormal thermal sagging occurs in a baking process carried out after the water-soluble polymer coated film is formed. It was found that this caused a pattern blockage defect. It has also been revealed that the pinholes produced by the caught air bubbles are more likely produced when the viscosity of the coating solution is higher.

The problem described above can be solved by increasing the amount of water-soluble polymer solution and covering a nearly entire surface of the wafer with the water-soluble polymer solution. However, since a much larger amount of solution is used, the manufacturing cost increases.

An exemplary embodiment provides a novel method for applying a coating liquid, a novel method for forming a coated film made of the coating liquid, a novel method for forming a pattern by using the same, and a novel method for manufacturing a semiconductor device and also provide an application method that uses a small amount of coating liquid but prevents pinhole defects from occurring without using a large amount of coating liquid, unlike the methods of related art described above.

### <Method for Applying Coating Liquid and Method for Forming Coated Film>

In an exemplary embodiment, a coating liquid is applied onto a substrate to form a coated film. An exemplary embodiment allows a coating nonuniformity-free coated film to be formed on a substrate even when a small amount of coating liquid is used.

Examples of the substrates include a disk-shaped plate (wafer) obtained by cutting an ingot into thin slices. The ingot is obtained by growing a seed crystal of silicon or any other suitable semiconductor material into a cylindrical shape. The diameter of a wafer varies and ranges from 50 to 300 mm, and a wafer having any of the diameters can be used. A resist layer, an Si layer, an oxide layer, or any other suitable layer may be formed on the surface of the substrate, and the layer may be patterned into a pattern with a stepped portion. Examples of the thus processed substrate include a substrate on which an anti-reflection film and a resist layer are formed and which undergoes an HMDS process (process of improving the adherence of a coated film) and a substrate on which a resist pattern (line pattern or hole pattern) is formed.

The coating liquid is a liquid to be applied onto a substrate for a specific purpose and can be selected as appropriate in accordance with the purpose. Specific examples of the coating liquid include resist solutions such as i-line photoresist solutions, KrF photoresist solutions and ArF photoresist solutions; anti-reflection film solutions; liquid-immersion top coat solutions; water-soluble polymer solutions such as shrink agent solutions; permanent resin solutions such as polyimide; burying solutions such as polysilazane; and application/planarization material solutions such as silica solution (spin coatable glass). The shrink agent solution is a chemical for shrinking a resist pattern, for example, RELACS agent and SAFIER agent. The coating liquid may be formed of a single liquid or two or more liquids.

The diluting liquid can be selected as appropriate from liquids capable of diluting a coating liquid. Specific examples of the diluting liquid may include water; alcohols such as methanol, ethanol, n-propanol and isopropyl alcohol; and non-water-soluble organic solvents such as propylene glycol monomethyl acetate and propylene glycol monomethyl ether. The diluting liquid may be formed of a single liquid or two or more liquids. The diluting liquid may contain an additive such as surfactant to improve the degree at which a mixture liquid spreads over a substrate.

The diluting liquid preferably contains a solvent that belongs to the same type of the solvent contained in the coating liquid, more preferably, is a solvent that belongs to the same type of the solvent contained in the coating liquid, still more preferably, is a solvent that is the same as the solvent contained in the coating liquid. For example, when the solvent contained in the coating liquid is water, the diluting liquid is preferably water or a mixture solvent of water and alcohol. When the solvent contained in the coating liquid is alcohol, the diluting liquid is preferably alcohol. The alcohol in this case may be the alcohol contained in the coating liquid or any other alcohol. When the solvent contained in the coating liquid is a non-water-soluble organic solvent, the diluting liquid is preferably a non-water-soluble organic solvent. The non-water-soluble organic solvent in this case may be the non-water-soluble organic solvent contained in the coating liquid or any other non-water-soluble organic solvent.

Specific examples of the combination of the coating liquid and the diluting liquid may include: (1) an aspect in which the coating liquid is a resist solution and the diluting liquid is a non-water-soluble organic solvent; (2) an aspect in which the coating liquid is an anti-reflection film solution or a liquid-immersion top coat solution and the diluting liquid is water, alcohol, or a mixture solvent thereof; and (3) an aspect in which the coating liquid is a shrink agent solution and the diluting liquid is water, alcohol, or a mixture solvent thereof.

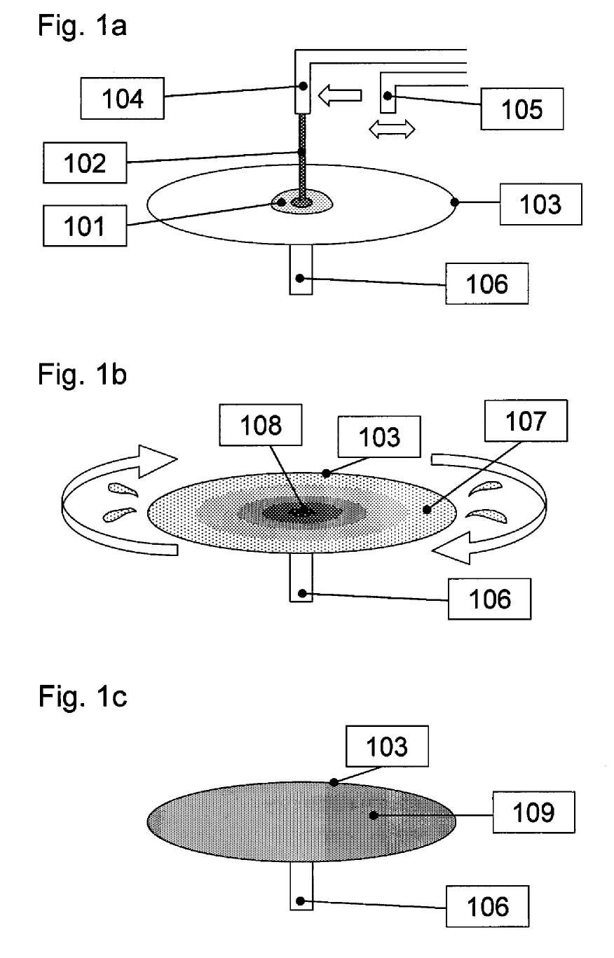

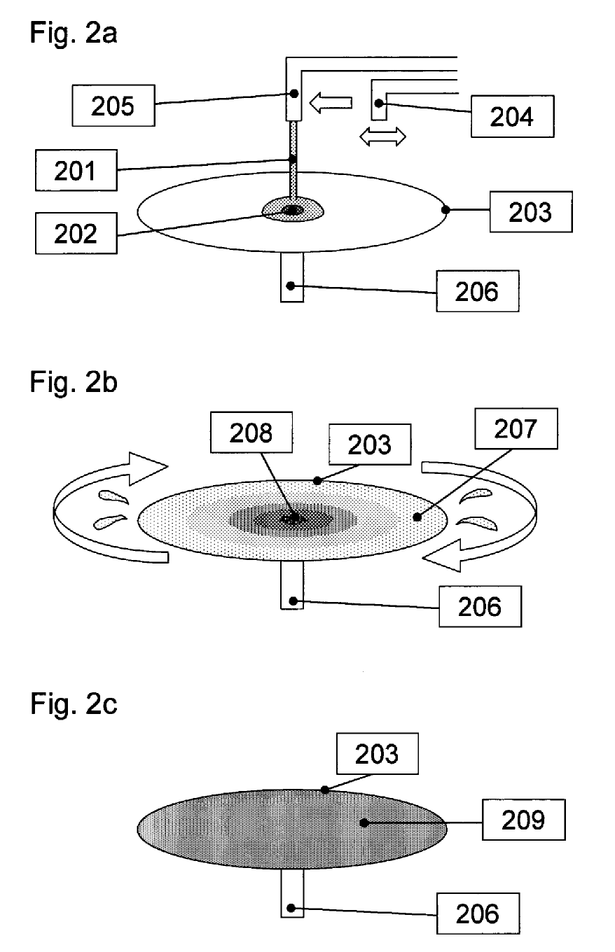

A method for applying a coating liquid according to an exemplary embodiment will be described below with reference to the drawings. FIGS. 1a, 1b, 1c, 2a, 2b and 2c diagrammatically show the steps of the method for applying a coating liquid according to an exemplary embodiment.

<Step (a1)>

In an exemplary embodiment described above, a puddle (P0) of a mixture liquid containing a coating liquid and a diluting liquid is formed on a substrate (step (a1)). That is, a puddle (P0) formed of a mixture liquid obtained by diluting a coating liquid with a diluting liquid and kept as a puddle under surface tension is formed on a substrate. The puddle of the mixture liquid (P0) is preferably formed to have a substantially circular shape. However, when a grid-like pattern, for example, is formed on the substrate, the puddle may have a round rectangular shape under the influence of the grid. A puddle (P0) in such a state is also acceptable.

First to fifth exemplary embodiments described below are exemplary methods for forming the puddle (P0) containing a coating liquid and a diluting liquid on a substrate.

In a first exemplary embodiment, before a coating liquid is dispensed on a substrate, a diluting liquid is dispensed to form the puddle (P0) of the mixture liquid formed of the coating liquid diluted with the diluting liquid (FIG. 1a). Specifically, a diluting liquid 101 is first dispensed through a diluting liquid supply nozzle 105 on a substrate 103 to form a puddle (P1) of the diluting liquid 101 (step (a1-11)). A coating liquid 102 is then dispensed through a coating liquid supply nozzle 104 on the puddle (P1) of the diluting liquid 101 formed on the substrate 103 to form the puddle (P0) of the mixture liquid containing the coating liquid 102 and the diluting liquid 101 (step (a1-12)).

In a second exemplary embodiment, after a coating liquid is dispensed on a substrate, a diluting liquid is dispensed to form the puddle (P0) of the mixture liquid formed of the coating liquid diluted with the diluting liquid (FIG. 2a). Specifically, a coating liquid 202 is first dispensed through a coating liquid supply nozzle 204 on a substrate 203 to form a puddle (P2) of the coating liquid 202 (step (a1-21)). A diluting liquid 201 is then dispensed through a diluting liquid supply nozzle 205 on the puddle (P2) of the coating liquid 202 formed on the substrate 203 to form the puddle (P0) of the mixture liquid containing the coating liquid 202 and the diluting liquid 201 (step (a1-22)).

In a third exemplary embodiment, before and after a coating liquid is dispensed on a substrate, a diluting liquid is dispensed to form the puddle (P0) of the mixture liquid formed of the coating liquid diluted with the diluting liquid. Specifically, a part of the diluting liquid is first dispensed through the diluting liquid supply nozzle on a substrate to form a puddle (P31) of the part of the diluting liquid (step (a1-31)). A coating liquid is then dispensed through the coating liquid supply nozzle on the puddle (P31) of the part of the diluting liquid formed on the substrate to form a puddle (P32) containing the coating liquid and the part of the diluting liquid (step (a1-32)). The remaining diluting liquid is then dispensed through the diluting liquid supply nozzle on the puddle (P32) formed on the substrate and containing the coating liquid and the part of the diluting liquid to form the puddle (P0) of the mixture liquid containing the coating liquid and the diluting liquid (step (a1-33)). For example, when the application facility has an upper limit of the period for which the diluting liquid is supplied, the diluting liquid is dispensed before and after the coating liquid is dispensed, as in a third exemplary embodiment. A desired amount of diluting liquid is thus readily dispensed.

In a fourth exemplary embodiment, a coating liquid and a diluting liquid are dispensed simultaneously on a substrate to form the puddle (P0) of the mixture liquid containing the coating liquid and the diluting liquid (step (a1-4)).

In a fifth exemplary embodiment, after a mixture liquid containing a coating liquid and a diluting liquid is prepared in advance (step (a1-51)), the mixture liquid is dispensed on a substrate to form the puddle (P0) of the mixture liquid containing the coating liquid and the diluting liquid (step (a1-52)). For example, the coating liquid and the diluting liquid can be mixed in an application apparatus immediately before the mixture liquid is dispensed on a wafer.

Alternatives may be a method in which a coating liquid is divided into two or more volumes and dispensing them one at a time or a method in which a diluting liquid is divided into three or more volumes and dispensing them one at a time. In any of these cases, the order in which the coating liquid and the diluting liquid are dispensed is arbitrary.

The puddle (P0) is formed of the mixture liquid obtained by diluting the coating liquid with the diluting liquid, and the mixture liquid may be a uniformly mixed liquid or may have concentration gradient.

The amounts of coating liquid and diluting liquid to be dispensed on a substrate can be set as appropriate to the extent that the puddle (P0) can maintain its puddle state under the surface tension of water. The amount of coating liquid to be dispensed typically ranges from 0.5 to 2.0 ml, and the amount of diluting liquid to be dispensed typically ranges from 5.0 to 10.0 ml. The dilution ratio can be set as appropriate in consideration of the degree of the effect of reducing the amount of coating liquid to be used, the thickness of the coated film to be formed, and other factors.

The position of the puddle (P0) formed on the substrate can be set as appropriate in consideration of the area of the substrate over which the coating liquid is applied. For example, when the coating liquid is applied over the entire surface of the wafer, it is preferable that the central position of the puddle (P0) substantially coincides with the central position of the substrate.

The substrate is preferably stationary, but may be rotated at a low speed at which a desired puddle (P0) can be formed (50 rpm or slower, for example).

<Step (a2-1) and Step (a2-2)>

In an exemplary embodiment, instead of carrying out the step (a1) described above, the diluting liquid can be dispensed on the substrate to cover the entire surface of the substrate with the diluting liquid (step (a2-1)), and then the coating liquid can be dispensed on the diluting liquid to form an area where the mixture liquid containing the coating liquid and the diluting liquid is present (step (a2-2)).

The amount of diluting liquid to be dispensed on the substrate is preferably large and ranges from 5.0 to 10.0 ml. On the other hand, the amount of coating liquid to be dispensed on the substrate is typically set at a value ranging from 0.5 to 2.0 ml.

The position on the substrate where the coating liquid is dispensed can be set as appropriate in consideration of the area of the substrate over which the coating liquid is applied. For example, when the coating liquid is applied over the entire surface of a wafer, it is preferable that the central position of the area over which the mixture liquid is present substantially coincides with the central position of the substrate.

The substrate is preferably stationary, but may be rotated at a low speed at which a desired area where a mixture liquid is present can be formed (50 rpm or slower, for example).

As described above, in an exemplary embodiment, a method in which the step (a1) is carried out or a method in which the steps (a2-1) and (a2-2) are carried out allows the mixture liquid containing the coating liquid and the diluting liquid to be present on the substrate. The steps are collectively referred to as a step (a).

<Step (b)>

In an exemplary embodiment, the mixture liquid provided in the step (a) is spread over the surface of the substrate (step (b)). In the step (b), the mixture liquid of the coating liquid and the diluting liquid is applied over the surface of the substrate. The step (b) is preferably carried out after the step (a). Alternatively, the step (b) may be initiated in the course of the step (a).

To spread the mixture liquid over the surface of the substrate, the substrate is, for example, rotated. FIGS. 1b/2b shows a state in which the substrate 103/203 is disposed on a rotatable stage 106/206 and the mixture liquid of the coating liquid and the diluting liquid is applied over the surface of the substrate by rotating the substrate to spread the mixture liquid over the surface of the substrate.

At this point, the mixture liquid may be spread in such a way that the concentration of the mixture liquid on the surface of the substrate is completely uniform. Alternatively, for example, the mixture liquid may be spread in such a way that a high-concentration mixture liquid 108/208 is present in the vicinity of the center of the substrate and a low-concentration mixture liquid 107/207 is present in the vicinity of the periphery of the substrate. Since the relatively low-viscosity (that is, relatively low-concentration) mixture liquid on the substrate is thus first diffused toward the periphery of the substrate, pinhole defects caused by caught air bubbles will not occur. Further, a coated film without pinhole defects can be formed by using a small amount of coating liquid. Moreover, even when a stepped resist portion is present, air bubbles will not caught at the stepped resist portion, whereby a coated film without pinhole defects can be formed. In this case, the film thickness is preferably made uniform by carrying out a later step (d).

The speed at which the substrate is rotated and the period for which the substrate is rotated can be set as appropriate to the extent that the mixture liquid can be spread over the entire surface of the substrate. The speed and the period typically range from 2000 to 4000 rpm and 0.5 to 2.0 seconds, respectively.

<Step (c)>

In an exemplary embodiment, the substrate can further be dried (step (c)). Drying the substrate removes the diluting liquid from the mixture liquid on the surface of the substrate, and a coated film of the coating liquid is formed on the surface of the substrate. Specifically, when a resist solution is used as the coating liquid, a resist layer is formed on the substrate. When an anti-reflection film solution or a liquid-immersion top coat solution is used as the coating liquid, an anti-reflection film or a liquid-immersion top-coat layer is formed on the substrate. When a shrink agent solution is used as the coating liquid, a shrink agent layer is formed on the substrate. To dry the substrate, the substrate is, for example, rotated. FIGS. 1c/2c shows a state in which a coated film 109/209 made of the coating liquid is formed on the surface of the substrate 103/203 by rotating the substrate 103/203.

The speed at which the substrate is rotated and the period for which the substrate is rotated to dry the substrate can be set as appropriate to the extent that the diluting liquid can be removed from the mixture liquid on the substrate. The speed and the period typically range from 1000 to 3000 rpm and 5 to 25 seconds, respectively.

<Step (d)>

In an exemplary embodiment, rotating the substrate before the step (c) can make the concentration of the mixture liquid, which has been spread over the surface of the substrate, uniform and can adjust the thickness of the formed coated film (step (d)). A uniform coated film having a desired thickness can thus be formed on the surface of the substrate.

The speed at which the substrate is rotated and the period for which the substrate is rotated can be set as appropriate to the extent that the concentration of the mixture liquid having been spread over the surface of the substrate can be made uniform. However, since rotating the substrate at high speed may make it difficult to form a coated film having a desired thickness, the rotating speed is preferably set at a speed slower than that used in the step (c). The speed and the period typically range from 1000 to 2500 rpm and 10 to 40 seconds, respectively.

### <Method for Forming Pattern>

In an exemplary embodiment, a method for forming a coated film described above is used to form a desired pattern on a substrate. According to an exemplary embodiment, a fine pattern can be formed uniformly on the entire surface of the substrate, and the amount of coating liquid used to form the pattern can be reduced.

The substrate can be the same one described above, and is not limited to a wafer but may be a reticle or a large glass plate used in a display or other similar apparatus. A pattern to be formed may be a line pattern or a hole pattern. The followings show methods for forming a desired pattern by using the method for forming a coated film described above:

### (1) Use for Forming Resist Layer:

A resist layer is formed on a substrate by using a method for forming a coated film described above. The resist layer can then be exposed and developed to form a resist pattern.

### (2) Use for Forming Anti-Reflection Film or Liquid-Immersion Top-Coat Layer:

An anti-reflection film or a liquid-immersion top-coat layer is formed on a substrate by using a method for forming a coated film described above. Before or after the anti-reflection film or the liquid-immersion top-coat layer is formed, a resist layer is formed on the substrate by using a typical method or a method for forming a coated film described above. The resist layer can then be exposed and developed to form a resist pattern. A process of baking and hardening the liquid-immersion top-coat layer and a process of washing away the liquid-immersion droplets can be carried out as required.

### (3) Use for Forming Shrink Agent Layer:

A resist pattern is first formed on a substrate. The method for forming the resist pattern may be a typical method or a method (1) or (2) described above. A shrink agent layer is then formed on the substrate, on which the resist pattern has been formed, by using a method for forming a coated film described above. Thereafter, the shrink agent layer is baked and rinsed to shrink the resist pattern. A fine pattern can thus be formed.

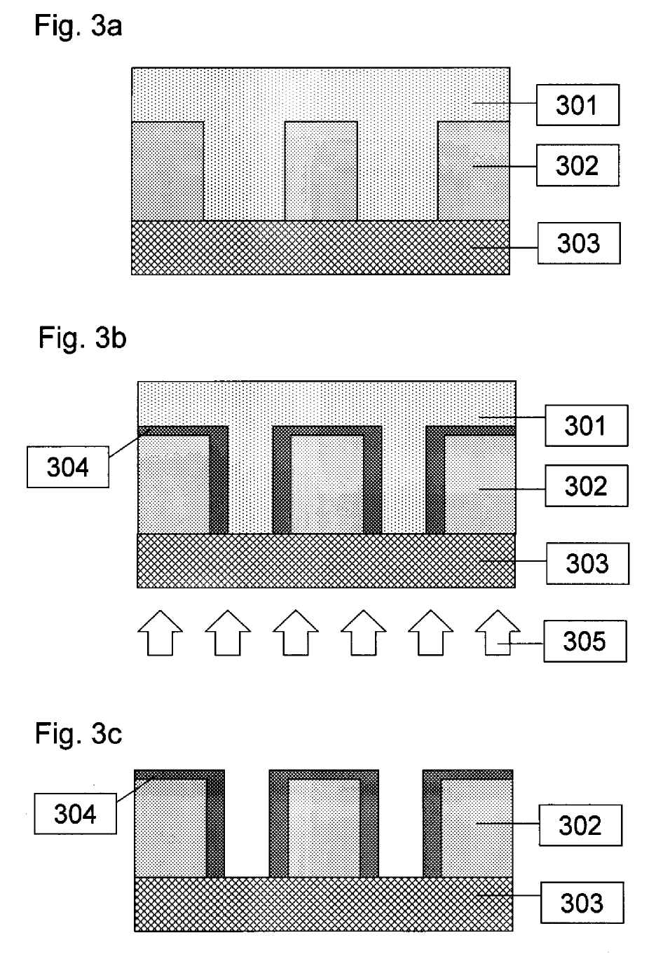

FIGS. 3a, 3b and 3c show the steps of shrinking a pattern by using a shrink agent. A shrink agent layer 301 is first formed on a substrate 303 on which a resist pattern 302 has been formed. At this point, the resist pattern 302 is buried in the shrink agent layer 301 (FIG. 3a). A baking process is then carried out to initiate a shrink reaction so that a pattern shrinking layer 304 is formed on the surface of the resist pattern 301 (FIG. 3b). Thereafter, the shrink agent layer 301 is removed by carrying out a water rinse process. A shrunk resist pattern is thus provided.

### <Method for Manufacturing Semiconductor Device>

In an exemplary embodiment, a semiconductor device is manufactured by forming a pattern on a semiconductor substrate by using a mask having a pattern formed by using a method for forming a pattern described above. A high-performance semiconductor device can thus be provided.

### EXAMPLES

### Example 1

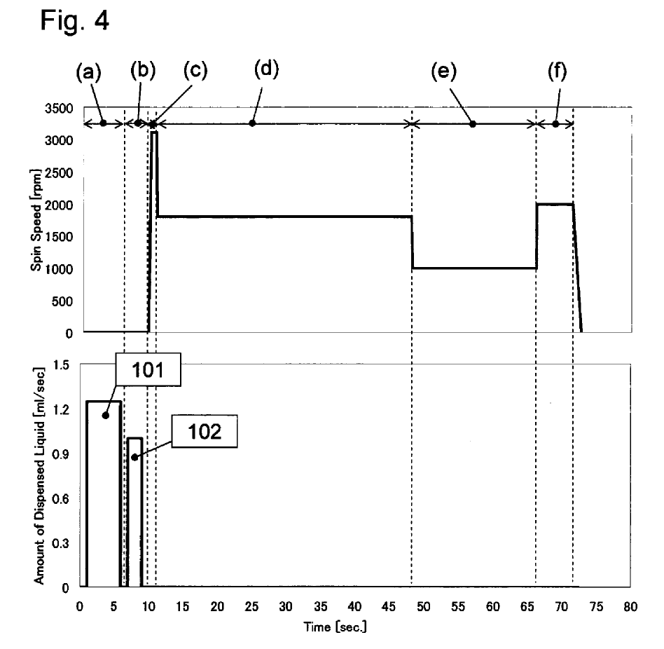

In Example 1, RELACS chemical liquid (trade name: AZ R602, hereinafter referred to as “R602”) manufactured by AZ Electronic Materials was applied onto a 300-mm wafer by using an exemplary embodiment shown in FIGS. 1a, 1b and 1c. FIG. 4 is a chart showing a time-dependent change of the spin speed of a substrate and the amount of each liquid to be dispensed in Example 1.

First, as the substrate 103, the 300-mm wafer on which a hole pattern had been formed by using an ArF resist (a methacrylic ArF resist manufactured by TOKYO OHKA KOGYO CO., LTD.) was transferred into an application cup (not shown).

The diluting liquid supply nozzle 105 was then moved to the central position of the wafer, and 6.25 ml of pure water as the diluting liquid 101 was dispensed on the stationary wafer ((a) in FIG. 4) to form a puddle of pure water on the wafer. In this process, since the surface of the wafer on which the resist hole pattern had been formed was hydrophobic, the pure water is in a puddle state under surface tension. After the supply of the pure water was terminated, the coating liquid supply nozzle 104 was in turn moved to the central position of the wafer, and 2 ml of R602 as the coating liquid 102 was dispensed on the puddle of pure water ((b) in FIG. 4) to form a puddle of the mixture liquid of the pure water and R602 (dilution ratio: approx. 25%) on the wafer. At this point, the mixture liquid was in a puddle state under surface tension (FIG. 1a), as in the case where only the pure water was present.

After the supply of R602 was terminated, the wafer was rotated at high speed in which the spin speed was increased to 3100 rpm at an acceleration of 10000 rpm/sec. The wafer was then maintained at the speed of 3100 rpm for 1.0 second ((c) in FIG. 4) so that the mixture liquid of the pure water and R602 was spread over the entire surface of the wafer (FIG. 1b). In this process, the excess mixture liquid was thrown away from the wafer.

Thereafter, to obtain an R602 coated film having a desired thickness, the spin speed of the wafer was reduced to 1800 rpm (at an acceleration of 10000 rpm/sec), and the wafer was dried for 35 seconds ((d) in FIG. 4). Thereafter, to wash the rear surface of the wafer, pure water was supplied through a rear surface washing nozzle for 18 seconds to wash the wafer, while the wafer was rotated at 1000 rpm ((e) in FIG. 4). The wafer then underwent a spin-drying process at 2000 rpm ((f) in FIG. 4). A desired R602 coated film was thus successfully formed (FIG. 1c).

Thereafter, the wafer on which the R602 coated film was formed was transferred onto a baking plate, where the wafer was baked at 165° C. for 90 seconds so that a shrink reaction was accelerated (not shown). Unnecessary R602 was rinsed away, and a shrunk hole pattern having a desired hole diameter was formed in a substantially uniform manner in the wafer plane, as in a case where an application method of relate art was used (not shown). Dry etching by using the resist pattern as a mask provided etched shapes and dimensions as excellent as those provided in a case where the application method of related art was used.

Further, when the method described above was applied to an ArF step of forming a 65-nm node and a DRAM was manufactured, devices having excellent characteristics were successfully manufactured at an excellent yield.

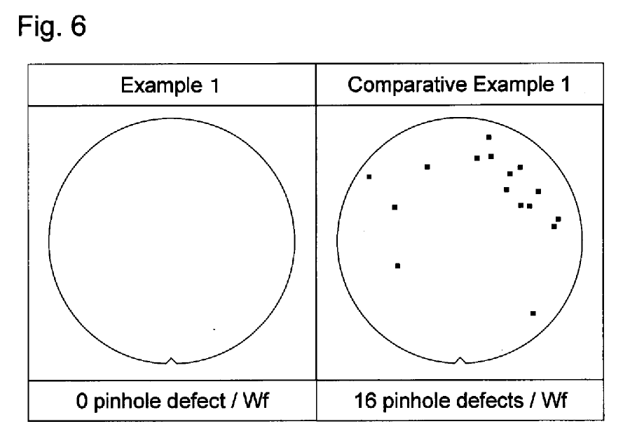

Pinhole defects produced was checked in a case where the application method of related art in the 60-nm node (Comparison Example) was used and in a case where the application method in Example 1 was used. The result shows that the pinhole defects produced in the application method of related art was significantly reduced in number as compared to the application method in Example 1, as shown in FIG. 6.

### Example 2

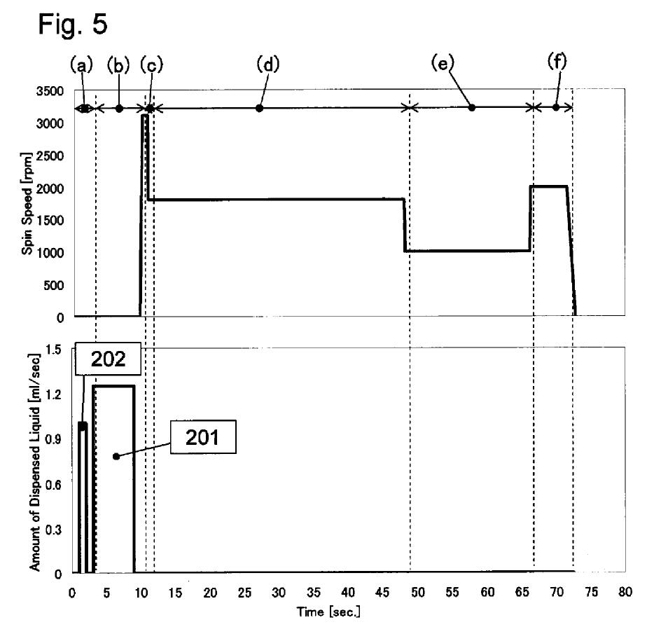

In Example 2, RELACS chemical liquid (trade name: AZ R200, hereinafter referred to as “R200”) manufactured by AZ Electronic Materials was applied onto a 300-mm wafer by using an exemplary embodiment shown in FIGS. 2a, 2b and 2c. FIG. 5 is a chart showing a time-dependent change of the spin speed of a substrate and the amount of each liquid to be dispensed in Example 2.

First, as the substrate 203, the 300-mm wafer on which a hole pattern had been formed by using a KrF resist (an acetal-based resist manufactured by Fuji Film Electronics Materials Co., Ltd.) was transferred into the application cup (not shown).

The coating liquid supply nozzle 204 was then moved to the central position of the wafer, and 2 ml of R200 as the coating liquid 202 was dispensed on the stationary wafer ((a) in FIG. 5) to form a puddle of R200 on the wafer. After the supply of R200 was terminated, the diluting liquid supply nozzle 205 was in turn moved to the central position of the wafer, and 6.25 ml of pure water as the diluting liquid 201 was dispensed on the puddle of R200 ((b) in FIG. 5) to form a puddle of the mixture liquid of the pure water and R200 (dilution ratio: approx. 25%) on the wafer. At this point, since the surface of the wafer on which the resist hole pattern had been formed was hydrophobic, the mixture liquid was in a puddle state under surface tension (FIG. 2a).

After the supply of the pure water was terminated, the wafer was rotated at high speed in which the spin speed was increased to 3100 rpm at an acceleration of 10000 rpm/sec. The wafer was then maintained at the speed of 3100 rpm for 1.0 second ((c) in FIG. 5) so that the mixture liquid of the pure water and R200 was spread over the entire surface of the wafer (FIG. 2b). In this process, the excess mixture liquid was thrown away from the wafer.

Thereafter, to obtain an R200 coated film having a desired thickness, the spin speed of the wafer was reduced to 1800 rpm (at an acceleration of 10000 rpm/sec), and the wafer was dried for 35 seconds ((d) in FIG. 5). Thereafter, to wash the rear surface of the wafer, pure water was supplied through the rear surface washing nozzle for 18 seconds to wash the wafer, while the wafer was rotated at 1000 rpm ((e) in FIG. 5). The wafer then underwent a spin-dry process at 2000 rpm ((f) in FIG. 5). A desired R200 coated film was thus successfully formed (FIG. 2c).

Thereafter, the wafer on which the R200 coated film was formed was transferred onto the baking plate, where the wafer was baked at 100° C. for 90 seconds so that a shrink reaction was accelerated (not shown). Unnecessary R200 was washed away by a solution of 10% IPA (isopropyl alcohol) in water, and a shrunk hole pattern having a desired hole diameter was formed in a substantially uniform manner in the wafer plane, as in a case where the application method of relate art was used (not shown). Dry etching by using the resist pattern as a mask provided etched shapes and dimensions as excellent as those provided in a case where the application method of related art was used.

Further, when the method described above was applied to a KrF step of forming a 65-nm node and a DRAM (Dynamic Random Access Memory) was manufactured, devices having excellent characteristics were successfully manufactured at an excellent yield.

An exemplary aspect of the invention includes the following Exemplary embodiments 1 to 24:

### Exemplary Embodiment 1

A method for applying a coating liquid onto a substrate, the method comprising:

(a1) forming a puddle (P0) of a mixture liquid comprising the coating liquid and a diluting liquid on the substrate; and

(b) spreading the mixture liquid over the surface of the substrate.

### Exemplary Embodiment 2

The method for applying a coating liquid according to Exemplary embodiment 1,

wherein the step (a1) comprises:

(a1-11) dispensing the diluting liquid on the substrate to form a puddle (P1) of the diluting liquid; and

(a1-12) dispensing the coating liquid on the puddle (P1) to form the puddle (P0) of the mixture liquid comprising the coating liquid and the diluting liquid.

### Exemplary Embodiment 3

The method for applying a coating liquid according to Exemplary embodiment 1,

wherein the step (a1) comprises:

(a1-21) dispensing the coating liquid on the substrate to form a puddle (P2) of the coating liquid; and

(a1-22) dispensing the diluting liquid on the puddle (P2) to form the puddle (P0) of the mixture liquid comprising the coating liquid and the diluting liquid.

### Exemplary Embodiment 4

The method for applying a coating liquid according to Exemplary embodiment 1,

wherein the step (a1) comprises: (a1-31) dispensing a part of the diluting liquid on the substrate to form a puddle (P31) of the part of the diluting liquid;

(a1-32) dispensing the coating liquid on the puddle (P31) to form a puddle (P32) comprising the coating liquid and the part of the diluting liquid; and

(a1-33) dispensing the remaining diluting liquid on the puddle (P32) to form the puddle (P0) of the mixture liquid comprising the coating liquid and the diluting liquid.

### Exemplary Embodiment 5

The method for applying a coating liquid according to Exemplary embodiment 1,

wherein the step (a1) is

(a1-4) dispensing the coating liquid and the diluting liquid simultaneously on the substrate to form the puddle (P0) of the mixture liquid comprising the coating liquid and the diluting liquid.

### Exemplary Embodiment 6

The method for applying a coating liquid according to Exemplary embodiment 1,

wherein the step (a1) comprises:

(a1-51) preparing a mixture liquid comprising the coating liquid and the diluting liquid; and

(a1-52) dispensing the mixture liquid on the substrate to form the puddle (P0) of the mixture liquid comprising the coating liquid and the diluting liquid.

### Exemplary Embodiment 7

A method for applying a coating liquid onto a substrate, the method comprising:

(a2-1) dispensing a diluting liquid on the substrate to cover the entire surface of the substrate with the diluting liquid;

(a2-2) dispensing the coating liquid on the diluting liquid to form an area where the mixture liquid comprising the coating liquid and the diluting liquid is present; and

(b) spreading the mixture liquid over the surface of the substrate.

### Exemplary Embodiment 8

The method for applying a coating liquid according to any one of Exemplary embodiments 1 to 7, wherein the substrate is rotated in the step (b).

### Exemplary Embodiment 9

The method for applying a coating liquid according to any one of Exemplary embodiments 1 to 8, further comprising

(c) drying the substrate.

### Exemplary Embodiment 10

The method for applying a coating liquid according to Exemplary embodiment 9, wherein the substrate is rotated in the step (c).

### Exemplary Embodiment 11

The method for applying a coating liquid according to Exemplary embodiment 10, further comprising, before the step (c),

(d) rotating the substrate at a spin speed slower than the spin speed in the step (c) to make the concentration of the mixture liquid having been spread over the surface of the substrate uniform and to adjust the thickness of a coated film to be formed.

### Exemplary Embodiment 12

The method for applying a coating liquid according to any one of Exemplary embodiments 1 to 11, wherein a pattern with a stepped portion is formed on the substrate.

### Exemplary Embodiment 13

The method for applying a coating liquid according to any one of Exemplary embodiments 1 to 12, wherein the coating liquid is any of a resist solution, an anti-reflection film solution, a liquid-immersion top coat solution, a water-soluble polymer solution, a permanent resin solution, a burying solution, and an application/planarization material solution.

### Exemplary Embodiment 14

The method for applying a coating liquid according to Exemplary embodiment 13, wherein the coating liquid is a resist solution and the diluting liquid is a non-water-soluble organic solvent.

### Exemplary Embodiment 15

The method for applying a coating liquid according to Exemplary embodiment 13, wherein the coating liquid is an anti-reflection film solution or a liquid-immersion top coat solution and the diluting liquid is water, alcohol, or a mixture solvent thereof.

### Exemplary Embodiment 16

The method for applying a coating liquid according to Exemplary embodiment 13, wherein the coating liquid is a shrink agent solution and the diluting liquid is water, alcohol, or a mixture solvent thereof.

### Exemplary Embodiment 17

A method for forming a coated film, the method comprising forming a coated film made of a coating liquid on a substrate by using the method for applying a coating liquid according to any one of Exemplary embodiments 1 to 13.

### Exemplary Embodiment 18

A method for forming a coated film, the method comprising forming a resist layer on a substrate by using the method for applying a coating liquid according to Exemplary embodiment 14.

### Exemplary Embodiment 19

A method for forming a coated film, the method comprising forming an anti-reflection film or a liquid-immersion top-coat layer by using the method for applying a coating liquid according to Exemplary embodiment 15.

### Exemplary Embodiment 20

A method for forming a coated film, the method comprising forming a shrink agent layer on a substrate by using the method for applying a coating liquid according to Exemplary embodiment 16.

### Exemplary Embodiment 21

A method for forming a pattern, the method comprising:

forming a resist layer on a substrate by using the method for forming a coated film according to Exemplary embodiment 18; and

exposing and developing the resist layer to form a resist pattern.

### Exemplary Embodiment 22

A method for forming a pattern, the method comprising:

forming a resist layer on a substrate;

before or after forming the resist layer, forming an anti-reflection film or a liquid-immersion top-coat layer on the substrate by using the method for forming a coated film according to Exemplary embodiment 19; and

exposing and developing the resist layer to form a resist pattern.

### Exemplary Embodiment 23

A method for forming a pattern, the method comprising:

forming a resist pattern on a substrate;

forming a shrink agent layer on the substrate by using the method for forming a coated film according to Exemplary embodiment 20; and

baking and rinsing the shrink agent layer to shrink the resist pattern.

### Exemplary Embodiment 24

A method for manufacturing a semiconductor device, the method comprising forming a pattern on a semiconductor substrate by using a mask having a pattern formed by using the method for forming a pattern according to any one of Exemplary embodiments 21 to 23.

What is claimed is:

1. A method for applying a coating liquid onto a substrate, the method comprising:
(a1) forming a puddle (P0) of a mixture liquid comprising the coating liquid and a diluting liquid on the substrate; and
(b) spreading the mixture liquid over the surface of the substrate.

2. The method for applying a coating liquid according to claim 1,
wherein the step (a1) comprises:
(a1-11) dispensing the diluting liquid on the substrate to form a puddle (P1) of the diluting liquid; and
(a1-12) dispensing the coating liquid on the puddle (P1) to form the puddle (P0) of the mixture liquid comprising the coating liquid and the diluting liquid.

3. The method for applying a coating liquid according to claim 1,
wherein the step (a1) comprises:
(a1-21) dispensing the coating liquid on the substrate to form a puddle (P2) of the coating liquid; and
(a1-22) dispensing the diluting liquid on the puddle (P2) to form the puddle (P0) of the mixture liquid comprising the coating liquid and the diluting liquid.

4. The method for applying a coating liquid according to claim 1,
wherein the step (a1) comprises:
(a1-31) dispensing a part of the diluting liquid on the substrate to form a puddle (P31) of the part of the diluting liquid;
(a1-32) dispensing the coating liquid on the puddle (P31) to form a puddle (P32) comprising the coating liquid and the part of the diluting liquid; and
(a1-33) dispensing the remaining diluting liquid on the puddle (P32) to form the puddle (P0) of the mixture liquid comprising the coating liquid and the diluting liquid.

5. The method for applying a coating liquid according to claim 1,
wherein the step (a1) is
(a1-4) dispensing the coating liquid and the diluting liquid simultaneously on the substrate to form the puddle (P0) of the mixture liquid comprising the coating liquid and the diluting liquid.

6. The method for applying a coating liquid according to claim 1,
wherein the step (a1) comprises:
(a1-51) preparing a mixture liquid comprising the coating liquid and the diluting liquid; and
(a1-52) dispensing the mixture liquid on the substrate to form the puddle (P0) of the mixture liquid comprising the coating liquid and the diluting liquid.

7. The method for applying a coating liquid according to claim 1, wherein the substrate is rotated in the step (b).

8. The method for applying a coating liquid according to claim 1, further comprising
(c) drying the substrate.

9. The method for applying a coating liquid according to claim 8, wherein the substrate is rotated in the step (c).

10. The method for applying a coating liquid according to claim 9, further comprising, before the step (c),
(d) rotating the substrate at a spin speed slower than the spin speed in the step (c) to make the concentration of the mixture liquid having been spread over the surface of the substrate uniform and to adjust the thickness of a coated film to be formed.

11. The method for applying a coating liquid according to claim 1, wherein a pattern with a stepped portion is formed on the substrate.

12. The method for applying a coating liquid according to claim 1, wherein the coating liquid is any of a resist solution, an anti-reflection film solution, a liquid-immersion top coat solution, a water-soluble polymer solution, a permanent resin solution, a burying solution, and an application/planarization material solution.

13. The method for applying a coating liquid according to claim 12, wherein the coating liquid is a resist solution and the diluting liquid is a non-water-soluble organic solvent.

14. The method for applying a coating liquid according to claim 12, wherein the coating liquid is an anti-reflection film solution or a liquid-immersion top coat solution and the diluting liquid is water, alcohol, or a mixture solvent thereof.

15. The method for applying a coating liquid according to claim 12, wherein the coating liquid is a shrink agent solution and the diluting liquid is water, alcohol, or a mixture solvent thereof.
